(19) United States
(12) Patent Application Publication
(10) Pub. No.: US 2021/0406790 A1
(43) Pub. Date: Dec. 30, 2021

(54) MODEL MONITORING METHOD AND EQUIPMENT APPLIED TO RISK CONTROL DECISION FLOW

(71) Applicant: Shanghai IceKredit, Inc., Shanghai (CN)

(72) Inventors: Lingyun Gu, Shanghai (CN); Zhipan Guo, Shanghai (CN); Wei Wang, Shanghai (CN); Shihao Tang, Shanghai (CN)

(21) Appl. No.: 17/229,016

(22) Filed: Apr. 13, 2021

(30) Foreign Application Priority Data
Jun. 29, 2020 (CN) 202010600190.6

(51) Int. Cl. G06Q 10/06; G06Q 40/02

(52) U.S. Cl. CPC G06Q 10/0635; G06Q 40/025; G06Q 10/0639

(57) ABSTRACT

Disclosed are a model monitoring method and equipment applied to a risk control decision flow. The method includes: collecting data to be processed from the data server through each data extraction program, and converting the data to be processed according to a preset format to obtain target data; obtaining decision information of each group of data to be processed; generating a first list according to the business application number and the decision information, and generating a second list according to the business application number and the business category identifier; integrating the first list and the second list to obtain a third list; and generating a ROC curve of the risk control decision model based on the third list, and performing index monitoring on the risk control decision model through the ROC curve.

### CROSS-REFERENCE TO RELATED APPLICATIONS

This application claims priority to Chinese Application No. 202010600190.6, filed on Jun. 29, 2020, the entire disclosure of which is incorporated herein by reference.

### TECHNICAL FIELD

The present disclosure relates to the technical field of risk control optimization of an online loan system, and in particular to a model monitoring method and equipment applied to a risk control decision flow.

### BACKGROUND

Currently, artificial intelligence models have been widely used in risk control decision flows. When the artificial intelligence model is running online, the actual performance of the model is of great concern. When using artificial intelligence models for data processing and identification in the risk control decision flow, the performance indexes of the artificial intelligence models need to be monitored.

When the model monitoring system is used to monitor the performance indexes of the artificial intelligence model in the risk control decision flow, the model monitoring system needs to collect business data from the business data provider docked with the artificial intelligence model, and then realize the performance index monitoring of the artificial intelligence model based on the business data. However, the data formats corresponding to different business data providers are different, which will increase the difficulty of docking between the model monitoring system and the business data provider, and it is difficult to ensure timely performance index monitoring of the artificial intelligence model.

### SUMMARY

In order to improve the above problems, the present disclosure provides a model monitoring method and equipment applied to a risk control decision flow.

According to a first aspect of the embodiment of the present disclosure, provided is a model monitoring method applied to a risk control decision flow, applied to a model monitoring device communicating with multiple data servers, wherein the model monitoring device is pre-equipped with a data extraction program corresponding to each data server, and the method includes:

collecting data to be processed from the data server through each data extraction program, and converting the data to be processed according to a preset format to obtain target data, wherein the target data includes a business application number, a business behavior mark value, and a business category identifier;

obtaining decision information of each group of data to be processed, wherein the decision information is generated after identifying request information corresponding to each group of data to be processed by a preset risk control decision model;

generating a first list according to the business application number and the decision information, and generating a second list according to the business application number and the business category identifier;

integrating the first list and the second list to obtain a third list; and

generating a ROC curve of the risk control decision model based on the third list, and performing index monitoring on the risk control decision model through the ROC curve.

In an embodiment, collecting data to be processed from the data server through each data extraction program, and converting the data to be processed according to a preset format to obtain target data includes:

collecting the data to be processed in a current time period of the data server corresponding to each data extraction program according to a preset collection frequency; and

cleaning the data to be processed, and formatting cleaned data to be processed according to a data format of the model monitoring device to obtain the target data.

In an embodiment, generating a ROC curve of the risk control decision model based on the third list includes:

determining a first cumulative value of a first business category identifier and a second cumulative value of a second business category identifier in the third list and a target business category identifier in each row of data in the third list;

calculating a first coordinate value and a second coordinate value corresponding to each row of data based on a first preset value, a second preset value, the first cumulative value, the second cumulative value, and the target business category identifier in each row of data; and

fitting the first coordinate value and the second coordinate value corresponding to each row of data to obtain the ROC curve.

In an embodiment, the method further includes:

extracting call data of the decision information within a preset time period; wherein the call data includes a first model output value of the risk control decision model relative to each group of data to be processed;

obtaining a recognition result of the risk control decision model for test data, and extracting distribution data in the recognition result, wherein the distribution data includes a second model output value of the risk control decision model relative to each group of test data;

determining a maximum model output value and a minimum model output value in the calling data and the distribution data;

generating a target interval using the minimum model output value as a first end point and using the maximum model output value as a second end point, and dividing the target interval into a plurality of subintervals;

determining first distribution information of the calling data in each interval and second distribution information of the distribution data in each interval; and

monitoring a group stability index of the risk control decision model according to each first distribution information and each second distribution information.

In an embodiment, the method further includes:

detecting whether a control instruction for accessing a target data server is received;

when receiving the control instruction, obtaining device information of the target data server, and generating a target data extraction program according to the target information included in the device information for indicating a target data format corresponding to the target data server; and

accessing the target data server to the model monitoring device through the target data extraction program; wherein the model monitoring device collects the data to be processed from the target data server through the target data extraction program.

According to a second aspect of the embodiment of the present disclosure, provided is a model monitoring equipment applied to a risk control decision flow, applied to a model monitoring device communicating with multiple data servers, wherein the model monitoring device is pre-equipped with a data extraction program corresponding to each data server, and the equipment includes:

a data collection module for collecting data to be processed from the data server through each data extraction program, and converting the data to be processed according to a preset format to obtain target data, wherein the target data includes a business application number, a business behavior mark value, and a business category identifier;

an information acquisition module for obtaining decision information of each group of data to be processed, wherein the decision information is generated after identifying request information corresponding to each group of data to be processed by a preset risk control decision model;

a list generation module for generating a first list according to the business application number and the decision information, and generating a second list according to the business application number and the business category identifier;

a list integration module for integrating the first list and the second list to obtain a third list; and

an index monitoring module for generating a ROC curve of the risk control decision model based on the third list, and performing index monitoring on the risk control decision model through the ROC curve.

In an embodiment, the data collection module is for:

collecting the data to be processed in a current time period of the data server corresponding to each data extraction program according to a preset collection frequency; and

cleaning the data to be processed, and formatting cleaned data to be processed according to a data format of the model monitoring device to obtain the target data.

In an embodiment, the index monitoring module is for:

determining a first cumulative value of a first business category identifier and a second cumulative value of a second business category identifier in the third list and a target business category identifier in each row of data in the third list;

calculating a first coordinate value and a second coordinate value corresponding to each row of data based on a first preset value, a second preset value, the first cumulative value, the second cumulative value, and the target business category identifier in each row of data; and

fitting the first coordinate value and the second coordinate value corresponding to each row of data to obtain the ROC curve.

In an embodiment, the index monitoring module is further for:

extracting call data of the decision information within a preset time period; wherein the call data includes a first model output value of the risk control decision model relative to each group of data to be processed;

obtaining a recognition result of the risk control decision model for test data, and extracting distribution data in the recognition result, wherein the distribution data includes a second model output value of the risk control decision model relative to each group of test data;

determining a maximum model output value and a minimum model output value in the calling data and the distribution data;

generating a target interval using the minimum model output value as a first end point and using the maximum model output value as a second end point, and dividing the target interval into a plurality of subintervals;

determining first distribution information of the calling data in each interval and second distribution information of the distribution data in each interval; and

monitoring a group stability index of the risk control decision model according to each first distribution information and each second distribution information.

In an embodiment, the equipment further includes a service access module, and the service access module is for:

detecting whether a control instruction for accessing a target data server is received;

when receiving the control instruction, obtaining device information of the target data server, and generating a target data extraction program according to the target information included in the device information for indicating a target data format corresponding to the target data server; and

accessing the target data server to the model monitoring device through the target data extraction program; wherein the model monitoring device collects the data to be processed from the target data server through the target data extraction program.

The present disclosure provides a model monitoring method and equipment applied to a risk control decision flow. The data extraction program corresponding to the data server is pre-deployed to collect the data to be processed from the corresponding data server and perform data format conversion on the data to be processed to obtain target data that can be used directly. Then, the first list and the second list are generated by combining the obtained decision information of the data to be processed, and the first list and the second list are integrated to obtain the third list, Finally, based on the third list, the ROC curve of the risk control decision model is generated to monitor the index of the risk control decision model. In this way, the data to be processed from different data servers can be collected and formatted through the preset data extraction program, which can reduce the difficulty of docking between the model monitoring device and the data server, to avoid the model monitoring device spending a lot of time for data format conversion, which can ensure that the model monitoring device performs timely performance index monitoring on the risk control decision model.

### BRIEF DESCRIPTION OF THE DRAWINGS

In order to explain the technical solutions of the embodiments of the present disclosure more clearly, the following will briefly introduce the drawings that need to be used in the embodiments. It should be understood that the following drawings only show some embodiments of the present disclosure, and therefore should not be regarded as limiting the scope. Those of ordinary skill in the art can obtain other related drawings according to these drawings without creative work.

FIG. 1 is a schematic diagram of a communication architecture of a model monitoring system applied to a risk control decision flow according to an embodiment of the present disclosure.

FIG. 2 is a flowchart of a model monitoring method applied to a risk control decision flow according to an embodiment of the present disclosure.

FIG. 3 is a block diagram of a model monitoring equipment applied to a risk control decision flow according to an embodiment of the present disclosure.

FIG. 4 is a schematic diagram of a hardware structure of a model monitoring device according to an embodiment of the present disclosure.

### DETAILED DESCRIPTION OF THE EMBODIMENTS

In order to better understand the above technical solutions, the technical solutions of the present disclosure will be described in detail below through the accompanying drawings and specific embodiments. It should be understood that the embodiments of the present disclosure and the specific features in the embodiments are detailed descriptions of the technical solutions of the present disclosure, rather than limitations on the technical solutions of the present disclosure. In the case of no conflict, the embodiments of the present disclosure and the technical features in the embodiments can be combined with each other.

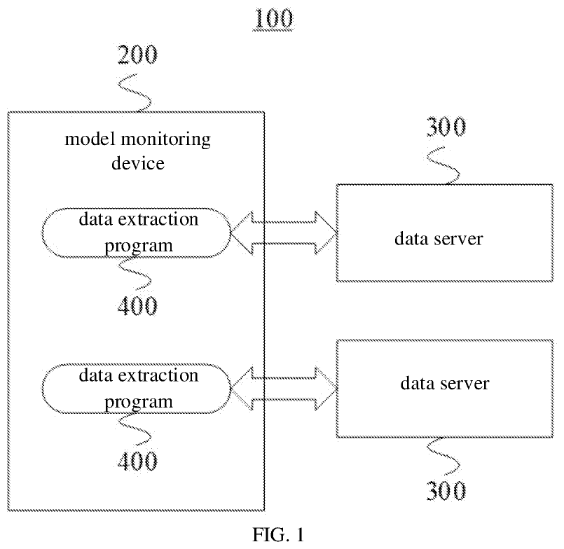

As shown in FIG. 1, FIG. 1 is a schematic diagram of a communication architecture of a model monitoring system 100 applied to a risk control decision flow according to an embodiment of the present disclosure. The model monitoring system 100 includes a model monitoring device 200 and a plurality of data servers 300. The model monitoring device 200 is pre-equipped with a data extraction program 400 corresponding to each data server 300.

In this embodiment, the data server 300 may be a server corresponding to an online loan system (for example, major banks and online loan companies, etc.). Further, the data extraction program can be an ETL tool, such as Datastage and Informatica.

The model monitoring device 200 can import the data to be processed of different styles/formats into the standard format internal database of the model monitoring device 200 through the ETL tool for storage, and use the stored data to perform index monitoring on the risk control decision model.

It can be understood that the foregoing system can be applied to multiple business scenarios, and this embodiment takes an online loan business scenario as an example for description.

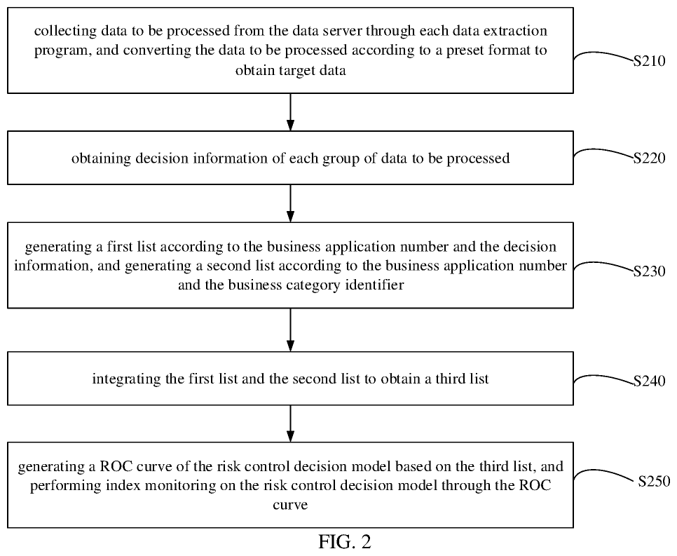

On the above basis, as shown in FIG. 2, FIG. 2 is a flowchart of a model monitoring method applied to a risk control decision flow according to an embodiment of the present disclosure. The method is applied to the model monitoring device 200 in FIG. 1, and may specifically include the content described in the following operations.

Operation S210, collecting data to be processed from the data server through each data extraction program, and converting the data to be processed according to a preset format to obtain target data.

In this embodiment, the data to be processed may be post-loan data. The business application number can be a loan number. The business behavior mark value can be the number of overdue times, which can be understood as the sum of the number of times the lender fails to repay the loan on time after the loan. The business category identifier indicates the nature of the loan as determined by the business. For example, the business category identifier “0” is used to indicate that the loan has no overdue behavior, and “1” is used to indicate that the loan has overdue behavior.

In this embodiment, the model monitoring device 200 collects data to be processed from different data servers 300 through different data extraction programs (ETL tools) and performs format conversion to obtain target data that the model monitoring device 200 can directly use.

Further, collecting data to be processed from the data server through each data extraction program, and converting the data to be processed according to a preset format to obtain target data specifically includes the following sub-operation S211 and sub-operation S212, which are described as follows.

Sub-operation S211, collecting the data to be processed in a current time period of the data server corresponding to each data extraction program according to a preset collection frequency; and

Sub-operation S212, cleaning the data to be processed, and formatting cleaned data to be processed according to a data format of the model monitoring device to obtain the target data.

In this embodiment, the preset collection frequency can be defined as f (such as one day or one week), and the current time period can be defined as P (such as one year), then, the model monitoring device 200 periodically extracts the post-loan data in the latest time period P from the external data server 300. It can be understood that the collected post-loan data is updated according to the preset collection frequency f.

Cleaning the data to be processed may include removing abnormal data. The abnormal data is data with missing data or data with abnormal values. Further, by performing format conversion of the data to be processed, the target data as shown in the following table can be obtained, for example.

| Loan number | Overdue time | Business category identifier |
|---|---|---|
| Loan_1 | 5 | 1 |
| Loan_2 | 0 | 0 |
| Loan_3 | 3 | 1 |

It can be understood that, through the above content, the business data to be processed can be extracted from different data servers 300 based on the data extraction program, cleaned and formatted, so as to obtain the above target data. In this way, there is no need to develop new code functions, and the cost of docking the model monitoring device 200 and the data server 300 can be reduced.

Operation S220, obtaining decision information of each group of data to be processed.

In operation S220, the decision information is generated after identifying the request information corresponding to each group of data to be processed by a preset risk control decision model. The requested information may be information related to the loan application. The decision information can also be understood as a model online running schedule as shown in the following table.

| | | | Model |
|---|---|---|---|
| Loan number | Model number | Call time | execution result |
| Loan_1 | Model_1 | 2020 Nov. 20 11:12:30 | 0.6784 |
| Loan_2 | Model_1 | 2020 Nov. 21 12:01:04 | 0.8766 |
| Loan_3 | Model_1 | 2020 Nov. 21 17:32:22 | 0.0321 |

In the above table, the loan number uniquely identifies each loan, the model number corresponds to which model the loan is run by, and the call time represents the time when the model is actually executed. The execution result of the model represents a score given to the loan by the model (the meaning of the specific score needs to be determined according to the specific model).

For example, the Loan_1 was executed by the Model_1 when applying, and the execution time of the model is 11:12:30 on Nov. 20, 2020, and the execution result is 0.6784, which means that for this loan, the Model_1 gives a score of 0.6784.

Operation S230, generating a first list according to the business application number and the decision information, and generating a second list according to the business application number and the business category identifier.

In this embodiment, first, extract the two columns of “loan number” and “model execution result” from the online model running table to obtain the first list, then extract the two columns of “loan number” and “business category identifier” from the table where the target data is located, and obtain the second list.

Operation S240, integrating the first list and the second list to obtain a third list.

In this embodiment, the first list and the second list can be internally joined to obtain the transition list, and then the transition list can be sorted in the order of the size of the model execution result, thereby obtaining the following third list.

| | | | Business category |
|---|---|---|---|
| Row number | Loan number | Model execution result | identifier |
| 1 | Loan_1 | 0.98 | 1 |
| 2 | Loan_1 | 0.87 | 1 |
| 3 | Loan_1 | 0.78 | 1 |
| 4 | Loan_1 | 0.68 | 0 |
| 5 | Loan_1 | 0.46 | 1 |
| 6 | Loan_1 | 0.44 | 0 |
| 7 | Loan_1 | 0.43 | 0 |
| 8 | Loan_1 | 0.23 | 0 |
| 9 | Loan_1 | 0.02 | 1 |
| 10 | Loan_1 | 0.01 | 0 |

Operation S250, generating a ROC curve of the risk control decision model based on the third list, and performing index monitoring on the risk control decision model through the ROC curve.

In this embodiment, generating a ROC curve of the risk control decision model based on the third list specially includes the following sub-operations S251-S253.

Sub-operation S251, determining a first cumulative value of a first business category identifier and a second cumulative value of a second business category identifier in the third list and a target business category identifier in each row of data in the third list;

Sub-operation S252, calculating a first coordinate value and a second coordinate value corresponding to each row of data based on a first preset value, a second preset value, the first cumulative value, the second cumulative value, and the target business category identifier in each row of data; and

Sub-operation S253, fitting the first coordinate value and the second coordinate value corresponding to each row of data to obtain the ROC curve.

For example, for the above third list, the first business category identifier may be “1” and the second business category identifier may be “0”, the first cumulative value may be c1, and the second cumulative value may be c2. Further, let L=1, the first preset value is SUM1=0, the second preset value is SUM2=0, and the set Q is an empty set. On the above basis, search for the data in the Lth row, assuming that the target business category identifier in the data in the L row is type, if type=1, then SUM1=SUM1+1, if type=0, then SUM0=SUM0+1.

Further, the first coordinate value x=SUM0/c0, and the second coordinate value y=SUM1/c1. It can be understood that each row of data corresponds to a set of (x, y), by self-adding L, the first coordinate value and the second coordinate value corresponding to each row of data can be added to the set Q, and the ROC curve can be obtained by fitting all the coordinate points in the set Q.

On the above basis, performing index monitoring on the risk control decision model through the ROC curve includes the following contents.

First, calculating the AUC value of the ROC curve.

In this embodiment, the AUC value is the area under the ROC curve, which is used to measure the predictive ability of the model. The higher the AUC value, the stronger the predictive ability of the model. Further, the AUC value can be calculated by the following formula:

$$AUC = \frac{1}{2} {\sum }_{i = 1}^{n - 1} ( {x}_{i + 1} - {x}_{i} ) ( {y}_{i} + {y}_{i + 1} ) ,$$

n represents the number of sample points in the set Q, and xᵢ and yᵢ represent the points (xᵢ, yᵢ) in the set Q.

Then, determining whether the AUC value reaches the preset threshold.

In this embodiment, the preset threshold can be adjusted according to actual conditions, which is not limited here. Further, if the AUC value reaches the preset threshold, the first monitoring information is output, and if the AUC value does not reach the preset threshold, the second monitoring information is output. The first monitoring information may be used to indicate that the predictive ability of the risk control decision model meets the preset standard, and the second monitoring information may be used to indicate that the predictive ability of the risk control decision model does not meet the preset standard.

In the above scheme, the risk control decision model is monitored based on the AUC value, and the predictive ability of the risk control decision model can be monitored in time.

Based on the above, the group stability index of the risk control decision model can also be monitored. When monitoring the group stability index, the group stability index value of the risk control decision model can be calculated, and then the model monitoring can be carried out based on the group stability index value. In this embodiment, the group stability index value is the PSI value.

Further, monitoring the group stability index of the risk control decision model may specifically include the contents described in the following sub-operation S261 to sub-operation S266.

Sub-operation S261, extracting call data of the decision information within a preset time period.

In this embodiment, the call data includes a first model output value of the risk control decision model relative to each group of data to be processed. For example, the call data is shown in the following table.

| Model number | Model output |
|---|---|
| Model_1 | 0.0XX |
| Model_1 | 0.1XX |
| Model_1 | 0.5XXX |

For example, the first output value may be 0.0XX, 0.1XX, and 0.5XXX.

Sub-operation S262, obtaining a recognition result of the risk control decision model for test data, and extracting distribution data in the recognition result.

For example, the distribution data is shown in the table below.

| Model number | Model output |
|---|---|
| Model_1 | 0.2212 |
| Model_1 | 0.1134 |
| Model_1 | 0.5650 |

In this embodiment, the distribution data includes a second model output value of the risk control decision model relative to each group of test data. For example, the second output value may be 0.2212, 0.1134, and 0.5650.

Sub-operation S263, determining a maximum model output value and a minimum model output value in the calling data and the distribution data.

For example, the set of all model outputs corresponding to the calling data is T1, and the set of all model outputs corresponding to the distribution data is T2. Then the maximum model output value max and the minimum model output value min can be found in the set T1 and the set T2.

Sub-operation S264, generating a target interval using the minimum model output value as a first end point and using the maximum model output value as a second end point, and dividing the target interval into a plurality of subintervals.

For example, the interval [min, max] can be equally divided into 10 parts, and the length of each interval is as follows: s=(max−min)/10.

Through the above division, 10 subintervals [min, min+s], (min+s, min+2s], (min+2s, min+3s], . . . , (min+9s, max) can be obtained.

Sub-operation S265, determining first distribution information of the calling data in each interval and second distribution information of the distribution data in each interval.

In this embodiment, the first distribution information and the second distribution information can be specifically obtained through the following table.

| | | T1 | | T2 |
|---|---|---|---|---|
| | T1 | distribution | T2 | distribution |
| Interval | distribution | proportion | distribution | proportion |
| [min, min + s] | 98 | 5.6% | 130 | 5% |
| (min + s, min2 | 87 | 5% | 110 | 4.3% |
| s) | | | | |
| (min + 2 s, | 103 | 5.9% | 140 | 5.5% |
| min + 3 s] | | | | |
| (min + 3 s, | 170 | 9.8% | 250 | 9.7% |
| min + 4 s] | | | | |
| (min + 4 s, | 23 | 1.3% | 70 | 2.7% |
| min + 5 s] | | | | |
| (min + 5 s, | 76 | 4.4% | 140 | 5.5% |
| min + 6 s] | | | | |
| (min + 6 s, | 980 | 56.4% | 1500 | 58.5% |
| min + 7 s] | | | | |
| (min + 7 s, | 56 | 3.2% | 66 | 2.6% |
| min + 8 s] | | | | |
| (min + 8 s, | 100 | 5.8% | 120 | 4.7% |
| min + 9 s] | | | | |
| (min + 9 s, | 45 | 2.6% | 10 | 1.6% |
| max] | | | | |
| Total | 1738 | 100% | 2566 | 100% |

Sub-operation S266, monitoring a group stability index of the risk control decision model according to each first distribution information and each second distribution information.

In sub-operation S266, first calculating the PSI value according to the first distribution information and the second distribution information, and then monitoring the group stability index of the risk control decision model according to the numerical range of the PSI value.

In this embodiment, the PSI value can be calculated by the following formula.

$$PSI = {\sum }_{i = 1}^{10} ( {d}_{i} - {v}_{i} ) In ( \frac{d}{{v}_{i}} )$$

In the above formula, dᵢ represents the actual proportion, corresponding to the T1 distribution proportion in the above table, and vᵢ indicates the expected proportion, corresponding to the T2 distribution proportion in the above table. Further, i indicates that it corresponds to the i-th interval, for example, d₁ corresponds to 5.6% in the above table, and v₁ corresponds to 5% in the above table. Through the above formula, the PSI value of the risk control decision model within a preset period of time can be calculated.

Further, monitoring the group stability index of the risk control decision model according to the numerical range of the PSI value includes the following contents.

If the PSI value is less than 0.1, the group stability index of the risk control decision model is determined to be a first stability level. If the PSI value is greater than or equal to 0.1 and less than 0.25, the group stability index of the risk control decision model is determined to be a second stability level. If the PSI value is greater than or equal to 0.25, the group stability index of the risk control decision model is determined to be a third stability level.

In this embodiment, the higher the stability level, the stronger the group stability of the risk control decision model. If the PSI value is greater than or equal to 0.25, the risk control decision model needs to be optimized.

It can be understood that through the above content, the performance index monitoring of the risk control decision model can be performed in time based on the PSI value, the ROC curve and the AUC value.

In an alternative embodiment, the method may also include the content described in the following operations (1) and (2).

(1) When detecting the control instruction, obtaining device information of the target data server, and generating a target data extraction program according to the target information included in the device information for indicating a target data format corresponding to the target data server.

(2) Accessing the target data server to the model monitoring device through the target data extraction program;

In this embodiment, the model monitoring device collects the data to be processed from the target data server through the target data extraction program.

It can be understood that through the content described in the above operations, real-time access to the target data server can be performed, so as to realize the real-time docking and update between the model monitoring device 200 and the data server.

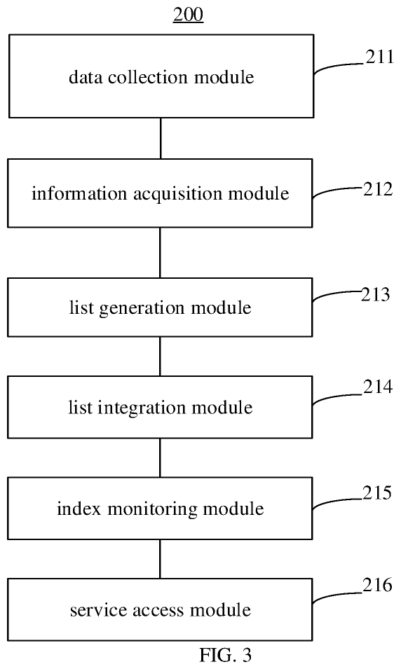

On the above basis, as shown in FIG. 3, FIG. 3 is a block diagram of a model monitoring equipment 210 applied to a risk control decision flow according to an embodiment of the present disclosure. The model monitoring equipment 210 includes a data collection module 211, an information acquisition module 212, a list generation module 213, a list integration module 214, and an index monitoring module 215.

The data collection module 211 is for collecting data to be processed from the data server through each data extraction program, and converting the data to be processed according to a preset format to obtain target data, wherein the target data includes a business application number, a business behavior mark value, and a business category identifier.

The information acquisition module 212 is for obtaining decision information of each group of data to be processed, wherein the decision information is generated after identifying request information corresponding to each group of data to be processed by a preset risk control decision model.

The list generation module 213 is for generating a first list according to the business application number and the decision information, and generating a second list according to the business application number and the business category identifier;

The list integration module 214 is for integrating the first list and the second list to obtain a third list.

The index monitoring module 215 is for generating a ROC curve of the risk control decision model based on the third list, and performing index monitoring on the risk control decision model through the ROC curve.

In an embodiment, the data collection module 211 is for:

collecting the data to be processed in a current time period of the data server corresponding to each data extraction program according to a preset collection frequency; and

cleaning the data to be processed, and formatting cleaned data to be processed according to a data format of the model monitoring device to obtain the target data.

In an embodiment, the index monitoring module 215 is for:

determining a first cumulative value of a first business category identifier and a second cumulative value of a second business category identifier in the third list and a target business category identifier in each row of data in the third list;

calculating a first coordinate value and a second coordinate value corresponding to each row of data based on a first preset value, a second preset value, the first cumulative value, the second cumulative value, and the target business category identifier in each row of data; and

fitting the first coordinate value and the second coordinate value corresponding to each row of data to obtain the ROC curve.

In an embodiment, the index monitoring module 215 is further for:

extracting call data of the decision information within a preset time period; wherein the call data includes a first model output value of the risk control decision model relative to each group of data to be processed;

obtaining a recognition result of the risk control decision model for test data, and extracting distribution data in the recognition result, wherein the distribution data includes a second model output value of the risk control decision model relative to each group of test data;

determining a maximum model output value and a minimum model output value in the calling data and the distribution data;

generating a target interval using the minimum model output value as a first end point and using the maximum model output value as a second end point, and dividing the target interval into a plurality of subintervals;

determining first distribution information of the calling data in each interval and second distribution information of the distribution data in each interval; and

monitoring a group stability index of the risk control decision model according to each first distribution information and each second distribution information.

In an embodiment, the equipment further includes a service access module 216, and the service access module 216 is for:

detecting whether a control instruction for accessing a target data server is received;

when receiving the control instruction, obtaining device information of the target data server, and generating a target data extraction program according to the target information included in the device information for indicating a target data format corresponding to the target data server; and

accessing the target data server to the model monitoring device through the target data extraction program; wherein the model monitoring device collects the data to be processed from the target data server through the target data extraction program.

Please refer to the description of the above method operations for the description of the above-mentioned data collection module 211, information acquisition module 212, list generation module 213, list integration module 214, index monitoring module 215, and service access module 216, and no further description is provided here.

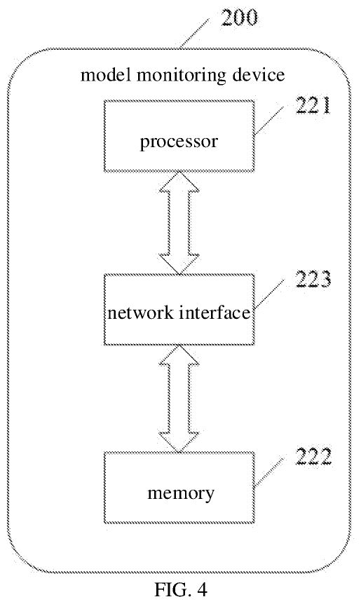

On the above basis, as shown in FIG. 4, FIG. 4 is a schematic diagram of a hardware structure of a model monitoring device 200 according to an embodiment of the present disclosure. The model monitoring device 200 includes a processor 221, a memory 222, and a network interface 223. The processor 221 and the memory 222 communicate through the network interface 223, and the processor 221 retrieves a computer program from the memory 222 through the network interface 223, and implements the aforementioned model monitoring method by executing the computer program.

In summary, the present disclosure provides a model monitoring method and equipment applied to a risk control decision flow. The data extraction program corresponding to the data server is pre-equipped to collect the data to be processed from the corresponding data server and perform data format conversion on the data to be processed to obtain target data that can be used directly. Then, the first list and the second list are generated by combining the obtained decision information of the data to be processed, and the first list and the second list are integrated to obtain the third list, Finally, based on the third list, the ROC curve of the risk control decision model is generated to monitor the index of the risk control decision model.

In this way, the data to be processed from different data servers can be collected and formatted through the preset data extraction program, which can reduce the difficulty of docking between the model monitoring device and the data server, to avoid the model monitoring device spending a lot of time for data format conversion, which can ensure that the model monitoring device performs timely performance index monitoring on the risk control decision model.

The above are only examples of the present disclosure, and are not used to limit the present disclosure. For those skilled in the art, the present disclosure can have various modifications and changes. Any modification, equivalent replacement, improvement, etc. made within the spirit and principle of this application shall be included in the scope of the claims of the present disclosure.

1. A model monitoring method applied to a risk control decision flow, applied to a model monitoring device communicating with multiple data servers, wherein the model monitoring device is pre-equipped with a data extraction program corresponding to each data server, and the method comprises:
collecting, by the model monitoring device, data to be processed from the data server through each data extraction program, and converting the data to be processed according to a preset format to obtain target data, wherein the target data includes a business application number, a business behavior mark value, and a business category identifier;
obtaining, by the model monitoring device, decision information of each group of data to be processed, wherein the decision information is generated after identifying request information corresponding to each group of data to be processed by a preset risk control decision model;
generating, by the model monitoring device, a first list according to the business application number and the decision information, and generating a second list according to the business application number and the business category identifier;
integrating, by the model monitoring device, the first list and the second list to obtain a third list; and
generating, by the model monitoring device, a ROC curve of the risk control decision model based on the third list, and performing index monitoring on the risk control decision model through the ROC curve;
the method further comprises:
extracting, by the model monitoring device, call data of the decision information within a preset time period; wherein the call data includes a first model output value of the risk control decision model relative to each group of data to be processed;
obtaining, by the model monitoring device, a recognition result of the risk control decision model for test data, and extracting distribution data in the recognition result, wherein the distribution data includes a second model output value of the risk control decision model relative to each group of test data;
determining, by the model monitoring device, a maximum model output value and a minimum model output value in the calling data and the distribution data;
generating, by the model monitoring device, a target interval using the minimum model output value as a first end point and using the maximum model output value as a second end point, and dividing the target interval into a plurality of subintervals;
determining, by the model monitoring device, first distribution information of the calling data in each interval and second distribution information of the distribution data in each interval; and
monitoring, by the model monitoring device, a group stability index of the risk control decision model according to each first distribution information and each second distribution information;
wherein the operation of performing, by the model monitoring device, index monitoring on the risk control decision model through the ROC curve comprises:
calculating, by the model monitoring device, an AUC value of the ROC curve;
determining, by the model monitoring device, whether the AUC value reaches a preset threshold; and
monitoring, by the model monitoring device, the risk control decision model based on the AUC value,
the operation of monitoring, by the model monitoring device, a group stability index of the risk control decision model according to each first distribution information and each second distribution information comprises:
calculating, by the model monitoring device, a population stability index (PSI) value according to the first distribution information and the second distribution information, and monitoring the group stability index of the risk control decision model according to a numerical range of the PSI value.

2. The method of claim 1, wherein collecting, by the model monitoring device, data to be processed from the data server through each data extraction program, and converting the data to be processed according to a preset format to obtain target data comprises:
collecting, by the model monitoring device, the data to be processed in a current time period of the data server corresponding to each data extraction program according to a preset collection frequency; and
cleaning, by the model monitoring device, the data to be processed, and formatting cleaned data to be processed according to a data format of the model monitoring device to obtain the target data.

3. The method of claim 1, wherein generating, by the model monitoring device, a ROC curve of the risk control decision model based on the third list comprises:
determining, by the model monitoring device, a first cumulative value of a first business category identifier and a second cumulative value of a second business category identifier in the third list and a target business category identifier in each row of data in the third list;
calculating, by the model monitoring device, a first coordinate value and a second coordinate value corresponding to each row of data based on a first preset value, a second preset value, the first cumulative value, the second cumulative value, and the target business category identifier in each row of data; and
fitting, by the model monitoring device, the first coordinate value and the second coordinate value corresponding to each row of data to obtain the ROC curve.

4. The method of claim 1, wherein the method further comprises:
detecting, by the model monitoring device, whether a control instruction for accessing a target data server is received;
when receiving the control instruction, obtaining, by the model monitoring device, device information of the target data server, and generating a target data extraction program according to the target information included in the device information for indicating a target data format corresponding to the target data server; and
accessing, by the model monitoring device, the target data server to the model monitoring device through the target data extraction program; wherein the model monitoring device collects the data to be processed from the target data server through the target data extraction program.

5. A model monitoring equipment applied to a risk control decision flow, applied to a model monitoring device communicating with multiple data servers, the model monitoring device comprises a processor, a network interface and a storage, the processor communicates with the network interface through the storage, and the model monitoring device executes following method:
collecting data to be processed from the data server through each data extraction program, and converting the data to be processed according to a preset format to obtain target data, wherein the target data includes a business application number, a business behavior mark value, and a business category identifier;
obtaining decision information of each group of data to be processed, wherein the decision information is generated after identifying request information corresponding to each group of data to be processed by a preset risk control decision model;
generating a first list according to the business application number and the decision information, and generating a second list according to the business application number and the business category identifier;
integrating the first list and the second list to obtain a third list; and
generating a ROC curve of the risk control decision model based on the third list, and performing index monitoring on the risk control decision model through the ROC curve;
the method further comprising:
extracting call data of the decision information within a preset time period; wherein the call data includes a first model output value of the risk control decision model relative to each group of data to be processed;
obtaining a recognition result of the risk control decision model for test data, and extracting distribution data in the recognition result, wherein the distribution data includes a second model output value of the risk control decision model relative to each group of test data;
determining a maximum model output value and a minimum model output value in the calling data and the distribution data;
generating a target interval using the minimum model output value as a first end point and using the maximum model output value as a second end point, and dividing the target interval into a plurality of subintervals;
determining first distribution information of the calling data in each interval and second distribution information of the distribution data in each interval; and
monitoring a group stability index of the risk control decision model according to each first distribution information and each second distribution information;
wherein performing index monitoring on the risk control decision model through the ROC curve further comprises:
calculating an AUC value of the ROC curve;
determining whether the AUC value reaches a preset threshold;
monitoring the risk control decision model based on the AUC value; and
calculating a population stability index (PSI) value according to the first distribution information and the second distribution information, and monitoring the group stability index of the risk control decision model according to a numerical range of the PSI value.

6. The equipment of claim 5, wherein collecting data to be processed from the data server through each data extraction program, and converting the data to be processed according to a preset format to obtain target data comprises:
collecting the data to be processed in a current time period of the data server corresponding to each data extraction program according to a preset collection frequency; and
cleaning the data to be processed, and formatting cleaned data to be processed according to a data format of the model monitoring device to obtain the target data.

7. The equipment of claim 5, wherein generating a ROC curve of the risk control decision model based on the third list comprises:
determining a first cumulative value of a first business category identifier and a second cumulative value of a second business category identifier in the third list and a target business category identifier in each row of data in the third list;
calculating a first coordinate value and a second coordinate value corresponding to each row of data based on a first preset value, a second preset value, the first cumulative value, the second cumulative value, and the target business category identifier in each row of data; and
fitting the first coordinate value and the second coordinate value corresponding to each row of data to obtain the ROC curve.

8. The equipment of claim 5, wherein the method further comprises:
detecting whether a control instruction for accessing a target data server is received;
when receiving the control instruction, obtaining device information of the target data server, and generating a target data extraction program according to the target information included in the device information for indicating a target data format corresponding to the target data server; and
accessing the target data server to the model monitoring device through the target data extraction program; wherein the model monitoring device collects the data to be processed from the target data server through the target data extraction program.
